(19) United States
(12) Patent Application Publication
(10) Pub. No.: US 2026/0154057 A1
(43) Pub. Date: Jun. 4, 2026

(54) RICH DATA LISTING FILE DEPLOYMENT

(71) Applicant: Snowflake Inc., Bozeman, MT (US)

(72) Inventors: Mohammed Abu Eseifan, Newark, CA (US); Peigen Sun, Sunnyvale, CA (US); Xiandong Ren, Hillsborough, CA (US)

(21) Appl. No.: 18/967,435

(22) Filed: Dec. 3, 2024

(51) Int. Cl. G06F 8/65; G06F 9/50; G06F 21/62; H04L 67/1036

(52) U.S. Cl. CPC G06F 8/65; G06F 9/5027; G06F 21/62; H04L 67/1036

(57) ABSTRACT

Described is a system for enabling third-party listing providers to upload cloud service listings and updates to a data platform across remote servers. Each listing includes rich data such as metadata, allowing customers to access data offerings directly. When a listing provider submits an update to a listing, the system updates a central ground truth storage layer to maintain the latest version of each listing. An update notification is then sent to multiple remote servers. Upon receiving a pull request from a remote server, the system transmits the updated listing to that server, allowing it to display the latest version to customers.

### TECHNICAL FIELD

Embodiments of the disclosure relate generally to cloud data platforms and, more specifically, to rich data listing file deployment.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to types of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a customer account. Indeed, the data platform may include one or more databases that are respectively maintained in association with any number of customer accounts, as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata in association with the data platform in general and in association with, as examples, particular databases and/or particular customer accounts as well.

Users and/or executing processes that are associated with a given customer account may, via one or more types of clients, be able to cause data to be ingested into the database, and may also be able to manipulate the data, add additional data, remove data, run queries against the data, generate views of the data, and so forth.

When certain information is to be extracted from a database, a query statement may be executed against the database data. A data platform may process the query and return certain data according to one or more query predicates that indicate what information should be returned by the query. The data platform extracts specific data from the database and formats that data into a readable form.

### BRIEF DESCRIPTION OF THE SEVERAL VIEWS OF THE DRAWINGS

The present disclosure will be apparent from the following more particular description of examples of embodiments of the technology, as illustrated in the accompanying drawings. The drawings are not necessarily to scale, emphasis instead being placed upon illustrating embodiments of the present disclosure. In the drawings, like numerals may describe similar components in different views. Like numerals having different letter suffixes may represent different instances of similar components. Various ones of the appended drawings merely illustrate example embodiments of the present disclosure and should not be considered as limiting its scope.

FIG. 1 illustrates an example computing environment that includes a cloud data platform, according to some examples.

FIG. 2 is a block diagram illustrating components of a compute service manager of the cloud data platform, according to some examples.

FIG. 3 is a method for distributing an update to a listing, according to some examples.

FIG. 4 is an architectural diagram illustrating creating and updating marketplace listings, according to some examples.

FIG. 5 is an architectural diagram illustrating joint collaboration on an update to a listing via a Git-based server repository, according to some examples.

FIG. 6 illustrates training and use of a machine-learning program, according to some examples.

FIG. 7 illustrates a machine-learning pipeline, according to some examples.

FIG. 8 illustrates a diagrammatic representation of a machine in the form of a computer system within which a set of instructions may be executed for causing the machine to perform any one or more of the methodologies discussed herein, in accordance with some examples of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure. The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail. For the purposes of this description, the phrase “cloud data platform” may be referred to as and used interchangeably with the phrases “a network-based database system,” “a database system,” or merely “a platform.”

In the present disclosure, physical units of data that are stored in a data platform—and that make up the content of, e.g., database tables in user accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the data platform, a given file is referred to herein as an “internal file” and may be stored in (or at, on, etc.) what is referred to herein as an “internal storage location.” If stored external to the data platform, a given file is referred to herein as an “external file” and is referred to as being stored in (or at, on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, eXtensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a user account. The data platform may include one or more databases that are respectively maintained in association with any number of user accounts (e.g., accounts of one or more data providers or other types of users), as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata (e.g., account object metadata) in association with the data platform in general and in association with, for example, particular databases and/or particular user accounts as well. Users and/or executing processes that are associated with a given user account may, via one or more types of clients, be able to cause data to be ingested into the database, and may also be able to manipulate the data, add additional data, remove data, run queries against the data, generate views of the data, and so forth.

In an implementation of a data platform, a given database (e.g., a database maintained for a user account) may reside as an object within, e.g., a user account, which may also include one or more other objects (e.g., users, roles, privileges, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

A data platform (e.g., database system) can support data storage for one or more different organizations (e.g., customer organizations, which can be individual companies or business entities), where each individual organization can have one or more accounts (e.g., customer accounts) associated with the individual organizations, and each account can have one or more users (e.g., unique usernames or logins with associated authentication information). Additionally, an individual account can have one or more users that are designated as an administrator for the individual account. An individual account of an organization can be associated with a specific cloud platform (e.g., cloud-storage platform, such as such as AMAZON WEB SERVICES™ (AWS™), MICROSOFT® AZURE®, GOOGLE CLOUD PLATFORM™), one or more servers or data centers servicing a specific region (e.g., geographic regions such as North America, South America, Europe, Middles East, Asia, the Pacific, etc.), a specific version of a data platform, or a combination thereof. A user of an individual account can be unique to the account. Additionally, a data platform can use an organization data object to link accounts associated with (e.g., owned by) an organization, which can facilitate management of objects associated with the organization, account management, billing, replication, failover/failback, data sharing within the organization, and the like.

The data platform includes a marketplace that enables seamless collaboration and exchange of data offerings. Designed as a dynamic data marketplace, the data platform can provide organizations with the ability to find, try, and purchase data offerings from third-party listing providers, facilitating data-driven decision-making. The marketplace serves as an ecosystem where listing providers can publish data products, APIs, and applications, and listing consumers can explore, evaluate, and integrate these offerings into their workflows with minimal effort.

The listing providers share their data offerings with potential consumers. Each listing acts as a digital storefront, presenting metadata that describes the offering, data samples for evaluation, and links to the underlying datasets offerings. Listings are designed to simplify discovery and onboarding, enabling consumers to securely access and distribute the data offerings without requiring complex integration or additional infrastructure. This approach fosters collaboration and empowers businesses to unlock the value of external datasets quickly and securely.

The marketplace supports a variety of use cases across industries. For example, financial institutions can access economic datasets for forecasting, while retail companies can leverage consumer behavior data for market analysis. Listing providers, who may be organizations or individual developers, upload their data products, APIs, or software as listings and enhance them with descriptive metadata, configuration files, and preview samples. Listing consumers, on the other hand, can explore the marketplace to find offerings tailored to their needs, try out samples to assess compatibility, and subscribe to these data offerings directly.

The data platform enables the listing providers to enrich their listings with rich data, such as images, videos, and/or executable code. Rich data provides visual and interactive elements that enhance the presentation of listings, improving discoverability and engagement for listing consumers. Additionally, the data platform introduces support for listing manifests, such as YAML files, which allow providers to define structured metadata and configuration details. These manifests standardize how listings are described and distributed, further simplifying onboarding for consumers.

By integrating these features, the marketplace evolves into a more dynamic and user-friendly ecosystem, enabling listing providers to create more compelling offerings and listing consumers to adopt data offerings more efficiently.

Traditional systems for managing cloud service listings often face significant challenges in providing real-time, consistent, and efficient updates across a distributed network. One major limitation is the lack of a centralized “source of truth” where the latest, verified version of a service listing is maintained. This deficiency often results in inconsistent versions across regions or servers, leading to listing consumer confusion, outdated data, and potential security vulnerabilities.

Additionally, traditional systems frequently rely on a push-based model for distributing updates, where the central system actively pushes updates to each server. This approach can be bandwidth-intensive, prone to errors, and challenging to scale, especially when dealing with large or complex datasets. Without a flexible update mechanism, traditional systems struggle with issues such as network congestion, failed transmissions, or delayed updates, which degrade service quality.

Furthermore, these systems often lack the ability to effectively manage executable code within listings, meaning listing consumers must perform manual setups or configuration steps. This manual process not only increases setup time and complexity but also introduces the potential for human error, leading to further inconsistencies and security risks. These deficiencies make traditional systems ill-suited for dynamic, cloud-based environments where agility, scalability, and consistent data availability are crucial.

Traditional systems often lack the capability for seamless, collaborative updates, making it difficult for multiple contributors to work simultaneously on cloud service listings. Managing collaborative changes becomes cumbersome and error-prone. Contributors must manually coordinate updates, track edits independently, and rely on communication outside the system, which increases the risk of version conflicts, duplicated work, and miscommunications.

There is also limited transparency, as traditional systems typically lack a comprehensive history of edits, making it challenging to trace changes, understand why specific modifications were made, or identify the origin of errors. Furthermore, these systems often lack an efficient rollback mechanism, so if an update introduces a problem, it can be difficult and time-consuming to revert to a stable version. This deficiency hampers the agility and reliability of traditional systems in maintaining complex, listings, especially in fast-paced cloud environments where rapid, synchronized updates are essential.

Aspects of the present disclosure address the foregoing issues, among others, with a data platform, systems, methods, and devices that integrate centralized management, automated distribution, and collaborative version control to streamline the deployment and updating of cloud service listings. The platform features a ground truth storage layer that serves as a single source of truth for all listings, ensuring consistency across distributed servers and eliminating the version discrepancies commonly seen in traditional systems. This centralized layer maintains the latest, verified version of each listing, so that remote servers always have access to the most up-to-date information.

To solve the inefficiencies of push-based models, the data platform uses a pull-based update mechanism that notifies remote servers when a new version of a listing is available. Each server autonomously requests the latest version from the ground truth layer, reducing network strain and improving scalability. This pull-based approach allows for flexible, efficient updates that adapt to regional network conditions, regulatory requirements, and specific server needs, minimizing the risks of delayed or failed transmissions.

Furthermore, the platform supports Git-based collaborative updates, enabling multiple contributors to manage listings in a coordinated, transparent manner. With Git integration, team members can work on separate branches, submit pull requests, and perform code reviews, which streamlines collaboration and reduces version conflicts. This capability ensures that each update undergoes a thorough review process before being committed to the ground truth storage layer, enhancing the quality and security of listings. If any issues arise with a new update, the platform's built-in version control allows for quick rollbacks to a stable version, reducing downtime and simplifying error recovery. By incorporating these features, the data platform addresses key limitations of traditional systems, offering a robust, efficient, and collaborative solution for managing cloud service listings.

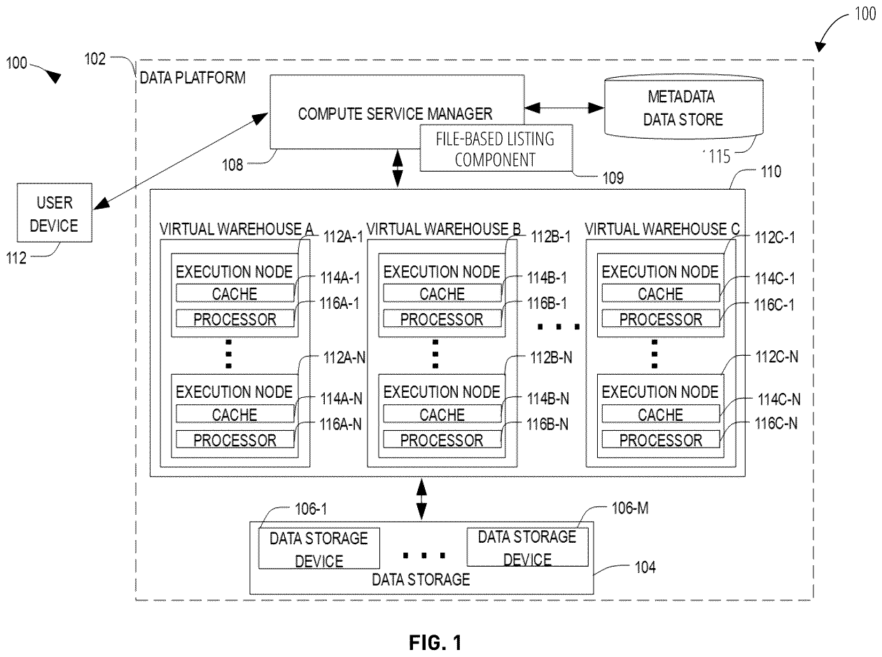

FIG. 1 illustrates an example computing environment 100 that includes a cloud data platform 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the cloud data platform 102 comprises a three-tier architecture: a compute service manager 108 coupled to a metadata data store 115, an execution platform 110, and data storage 104. The cloud data platform 102 hosts and provides data access, management, reporting, and analysis services to multiple client accounts. Administrative users can create and manage identities (e.g., users, roles, and groups) and use permissions to allow or deny access to the identities to resources and services. The cloud data platform 102 is used for reporting and analysis of integrated data from one or more disparate sources including storage devices within the data storage 104. The data storage 104 comprises a plurality of computing machines and provides on-demand computer system resources such as data storage and computing power to the cloud data platform 102.

The compute service manager 108 includes multiple services that coordinate and manage operations of the cloud data platform 102. For example, the compute service manager 108 is responsible for performing query optimization and compilation as well as managing clusters of compute nodes that perform query processing (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also coupled to the metadata data store 115. The metadata data store 115 stores metadata pertaining to various functions and aspects associated with the cloud data platform 102 and its users. The metadata data store 115 also includes a summary of data stored in data storage 104 as well as data available from local caches. Additionally, the metadata data store 115 includes information regarding how data is organized in the data storage 104 and the local caches.

As shown, the compute service manager 108 includes a file-based listing component 109 that is responsible for streamlining the management, deployment, and updating of service listings with a focus on consistency, collaboration, and security. Featuring a centralized ground truth storage layer and Git-based version control, the data platform enables real-time synchronization across distributed servers and allows multiple collaborators to efficiently manage and update listings. With automated, pull-based update distribution and built-in rollback capabilities, the data platform ensures that users receive the latest verified versions, minimizing downtime and enhancing reliability in dynamic cloud environments. Further details of the operation of the file-based listing component 109 are discussed below.

The compute service manager 108 is also in communication with a user device 112. The user device 112 corresponds to a user of one of the multiple client accounts supported by the cloud data platform 102. In some implementations, the compute service manager 108 does not receive any direct communications from the user device 112 and only receives communications concerning jobs from a queue within the cloud data platform 102.

The compute service manager 108 is also coupled to the metadata data store 115. The metadata data store 115 stores metadata pertaining to various functions and aspects associated with the cloud data platform 102 and its users. The metadata data store 115 also includes a summary of data stored in data storage 104 as well as data available from local caches. Additionally, the metadata data store 115 includes information regarding how data is organized in the data storage 104 and the local caches.

The compute service manager 108 is further coupled to the execution platform 110, which includes multiple virtual warehouses (computing clusters) that execute various data storage and data retrieval tasks. As an example, a set of processes on a compute node executes at least a portion of a query plan compiled by the compute service manager 108. As shown, the execution platform 110 includes virtual warehouse A, virtual warehouse B, and virtual warehouse C. Each virtual warehouse includes multiple execution nodes that each includes a data cache and a processor. For example, as shown, virtual warehouse A includes execution nodes 112A-1 to 112A-N; execution node 112A-1 includes a cache 114A-1 and a processor 116A-1; and execution node 112A-N includes a cache 114A-N and a processor 116A-N. Similarly, in this example, virtual warehouse B includes execution nodes 112B-1 to 112B-N; execution node 112B-1 includes a cache 114B-1 and a processor 116B-1; and execution node 112B-N includes a cache 114B-N and a processor 116B-N. Additionally, virtual warehouse C includes execution nodes 112C-1 to 112C-N; execution node 112C-1 includes a cache 114C-1 and a processor 116C-1; and execution node 112C-N includes a cache 114C-N and a processor 116C-N.

Each execution node of the execution platform 110 is assigned to processing one or more data storage and/or data retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 110 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 110 may include any number of virtual warehouses. Additionally, the number of virtual warehouses in the execution platform 110 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 1 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 1 each include a single data cache and a single processor, in other examples, execution nodes can contain any number of processors and any number of caches. Also, the caches may vary in size among the different execution nodes.

In some examples, the virtual warehouses of the execution platform 110 operate on the same data, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Although virtual warehouses A, B, and C are illustrated with an association with the same execution platform 110, the virtual warehouses may be implemented using multiple computing systems at multiple geographic locations. For example, virtual warehouse A can be implemented by a computing system at a first geographic location, while virtual warehouses B and C are implemented by another computing system at a second geographic location. In some examples, these different computing systems are cloud-based computing systems maintained by one or more different entities.

The execution platform 110 is coupled to data storage 104. The data storage 104 comprises multiple data storage devices 106-1 to 106-M. In some embodiments, the data storage devices 106-1 to 106-M are cloud-based storage devices located in one or more geographic locations. For example, the data storage devices 106-1 to 106-M may be part of a public cloud infrastructure or a private cloud infrastructure. The data storage devices 106-1 to 106-M may be hard disk drives (HDDs), solid state drives (SSDs), storage clusters, Amazon S3™ storage systems or any other data storage technology. Additionally, the data storage 104 may include distributed file systems (e.g., Hadoop Distributed File Systems (HDFS)), object storage systems, and the like. In some examples, the storage devices 106-1 to 106-M are managed and provided by a third-party data storage platform (e.g., AWS®, Microsoft Azure Blob Storage®, or Google Cloud Storage®).

Each virtual warehouse can access any of the data storage devices 106-1 to 106-M shown in FIG. 1. Thus, the virtual warehouses are not necessarily assigned to a specific data storage device 106-1 to 106-M and, instead, can access data from any of the data storage devices 106-1 to 106-M within the data storage 104. Similarly, each of the execution nodes shown in FIG. 1 can access data from any of the data storage devices 106-1 to 106-M. In some examples, a particular virtual warehouse or a particular execution node may be temporarily assigned to a specific data storage device, but the virtual warehouse or execution node may later access data from any other data storage device.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another.

As shown in FIG. 1, the data storage devices 106-1 to 106-M are decoupled from the computing resources associated with the execution platform 110. This architecture supports dynamic changes to the cloud data platform 102 based on the changing data storage/retrieval needs as well as the changing needs of the users and systems. The support of dynamic changes allows the cloud data platform 102 to scale quickly in response to changing demands on the systems and components within the cloud data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

During typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more execution nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the metadata data store 115 assists the compute service manager 108 in determining which nodes in the execution platform 110 have already cached at least a portion of the data needed to process the task. One or more nodes in the execution platform 110 process the task using data cached by the nodes and, if necessary, data retrieved from the data storage 104.

The compute service manager 108, metadata data store 115, execution platform 110, and data storage 104 are shown in FIG. 1 as individual discrete components. However, each of the compute service manager 108, metadata data store 115, execution platform 110, and data storage 104 may be implemented as a distributed system (e.g., distributed across multiple systems/platforms at multiple geographic locations). Additionally, each of the compute service manager 108, metadata data store 115, execution platform 110, and data storage 104 can be scaled up or down (independently of one another) depending on changes to the requests received and the changing needs of the cloud data platform 102. Thus, in the described embodiments, the cloud data platform 102 is dynamic and supports regular changes to meet the current data processing needs.

As shown in FIG. 1, the computing environment 100 separates the execution platform 110 from the data storage 104. In this arrangement, the processing resources and cache resources in the execution platform 110 operate independently of the data storage devices 106-1 to 106-M in the data storage 104. Thus, the computing resources and cache resources are not restricted to specific data storage devices 106-1 to 106-M. Instead, all computing resources and all cache resources may retrieve data from, and store data to, any of the data storage resources in the data storage 104.

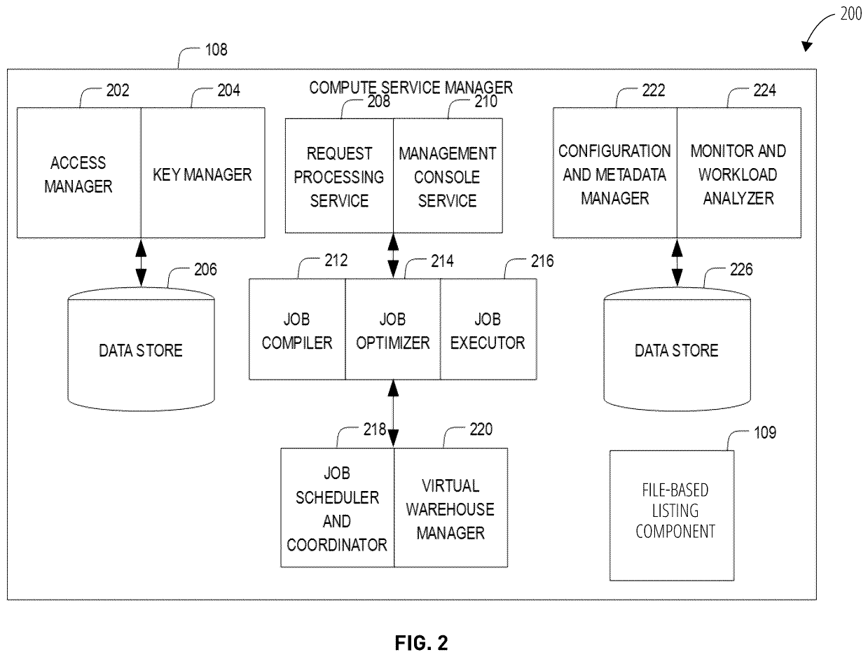

FIG. 2 is a block diagram illustrating components of the compute service manager 108, in accordance with some embodiments of the present disclosure. As shown in FIG. 2, the compute service manager 108 includes an access manager 202 and a key manager 204 coupled to a data store 206 that stores access information. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 104).

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 identifies or assigns particular nodes in the execution platform 110 to process particular tasks.

A virtual warehouse manager 220 manages the operation of multiple virtual warehouses implemented in the execution platform 110. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage units need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., “external”) query workload that may also be processed by the execution platform 110. The configuration and metadata manager 222 and the monitor and workload analyzer 224 are coupled to a data store 226. Data store 226 in FIG. 2 represents any data repository or device within the cloud data platform 102. For example, data store 226 may represent caches in execution platform 110, storage devices in data storage 104, the metadata data store 115, or any other storage device or system.

In addition, as mentioned above, the compute service manager 108 includes a file-based listing component 109 that is responsible for streamlining the management, deployment, and updating of service listings with a focus on consistency, collaboration, and security. Featuring a centralized ground truth storage layer and Git-based version control, the platform enables real-time synchronization across distributed servers and allows multiple collaborators to efficiently manage and update listings. With automated, pull-based update distribution and built-in rollback capabilities, the platform ensures that users receive the latest verified versions, minimizing downtime and enhancing reliability in dynamic cloud environments. Further details regarding the functionality of the file-based listing component 109 are discussed below.

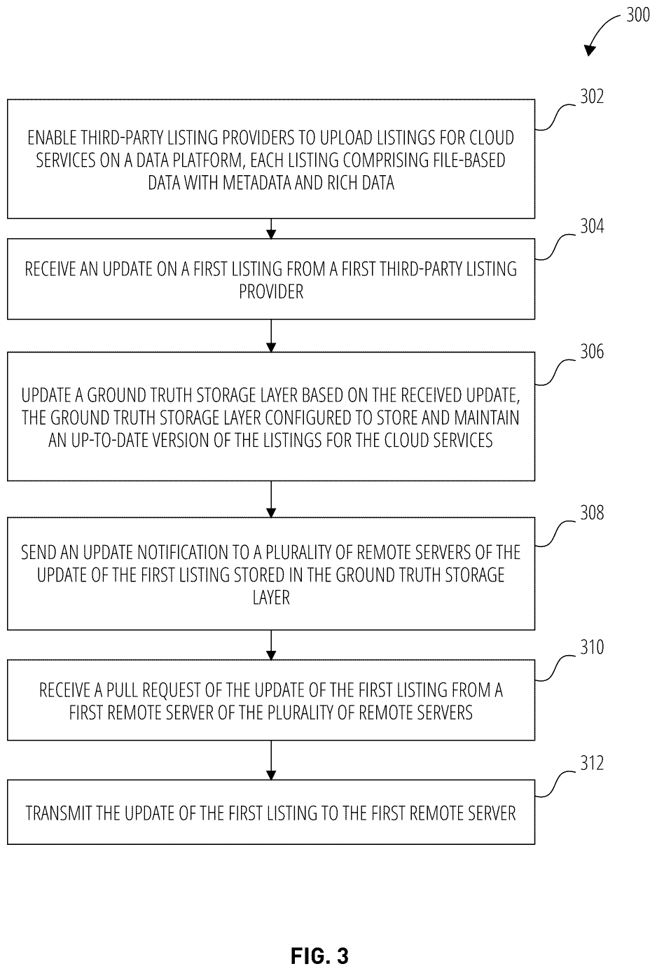

FIG. 3 illustrates a method 300 for distributing an update to a listing, according to some examples. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

FIG. 3 is described as being performed by certain systems or applying certain processes, such as a particular machine learning model, but the processes described herein can be performed by one or more other or the same machine learning models.

At block 302, the data platform enables third-party listing providers to upload listings for data offerings. In some cases, the listing includes textual descriptions. In other cases, the listing includes textual descriptions that include rich data, such as images, videos, interactive media and manifest files. The data platform includes a marketplace where third-party listing providers—can list their data offerings by publishing the data offerings as listings on the marketplace.

This marketplace structure enables listing providers to reach a wide listing consumer base who rely on the platform to find, purchase, and integrate various data offerings. The data platform functions as a centralized cloud environment where listing providers can showcase and offer their data offerings to potential listing consumers in an efficient and organized way.

This marketplace is designed to facilitate the discovery, purchase, and distribution of data offerings directly on the platform, streamlining interactions between service providers (listing providers) and users (listing consumers). The marketplace structure enables listing provider visibility and accessibility whereby listing providers can create a presence on the platform, allowing potential listing consumers to browse their data offerings, access detailed information, and evaluate the offerings based on functionality, customer reviews, and other criteria.

The data platform facilitates service adoption for listing consumers whereby listing consumers on the platform can explore and acquire cloud solutions directly from the marketplace, where in some cases, without having to integrate external applications or solutions manually.

In block 302, the data platform facilitates the onboarding of listing provider services by allowing third-party listing providers to create listings. Each listing is a structured digital entry within the marketplace, designed to provide a complete representation of the listing provider's service. The file-based listings can include different types of data, such as metadata and rich data.

Metadata can help listing consumers understand the context, purpose, and functionality of the listing providers 's data listing. The metadata can include descriptive information such as title and description which summarizes the data offering and category which can help with categorization within the marketplace, making the data offering easily searchable for listing consumers. The listing can also include licensing and pricing information which provides information on the terms of use, and costs, customer reviews and ratings that allow potential users to see feedback from other listing consumers, contact information and support links that give listing consumers access to resources or support channels offered by the listing providers, and/or the like.

Listings can include more than textual based metadata. In some cases, the listing includes rich data such as images, videos, interactive components, and examples and demos that include executable code that help to enrich and better describe the data offering. The executable code can include manifest files that may automate installation steps, configure settings, or initialize connections between the listing provider's service and the listing consumer's environment, APIs and application files that enable deeper integration with the data platform, allowing the service to interact seamlessly with other applications or data, configuration files that provide settings and parameters needed for optimal performance of the service, supporting documentation that include technical guides, usage instructions, and best practices to help listing consumers understand how to distribute and use the data effectively, and/or interactive elements that may include dashboards, data visualizations, or other interactive features that showcase the data's functionality and help listing consumers assess its value.

The manifest files can include metadata for the listing itself. Some examples of the manifest files can include a title, description of the listing, target accounts or regions that the listing is to be published, replication settings for data included in the listing, and/or the like. In some cases, the manifest files include pricing plans.

In some cases, the manifest files can play a pivotal role in automating installation, configuring settings, and initializing connections between the listing provider's service and the listing consumer's environment. These files now benefit from being stored as discrete files that are replicated alongside other rich data within the data platform. This approach introduces a powerful capability of maintaining multiple snapshots of the manifest file for the same listing, each representing a version at a specific point in time. By storing these versions, the platform enables listing providers to manage the lifecycle of their listings more effectively.

This versioning capability provides listing providers with the flexibility to rollback to a previous version of the manifest file if necessary. For example, if an update introduces unintended issues or misconfigurations, the provider can seamlessly revert to a prior, stable version of the manifest, restoring the listing's functionality without additional manual adjustments. Providers can manage these versions directly within the data platform or through integrated tools like Git, ensuring a smooth and efficient process for version control. Additionally, this functionality supports enhanced collaboration and troubleshooting, as providers can track changes over time, identify the source of errors, and ensure consistent deployment of listings across regions and environments.

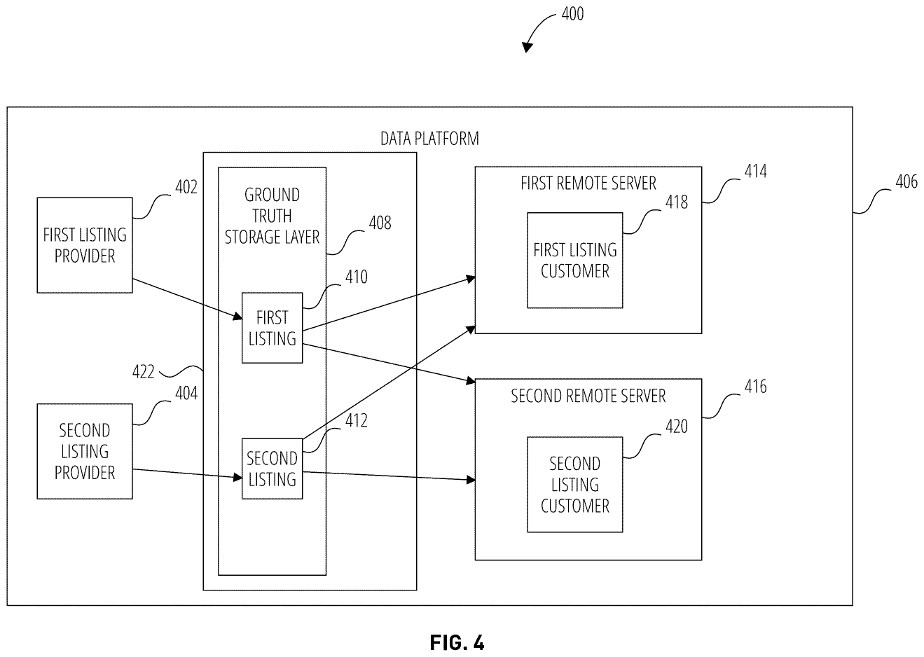

FIG. 4 is an architectural diagram 400 illustrating creating and updating marketplace listings, according to some examples. A first listing provider 402 can create a first listing 410 on a data platform 406 on a remote server 422. The first listing data can be uploaded by the first listing provider and stored in a ground truth storage layer 408. A second listing provider 404 can also upload a second listing 412 to the data platform.

A notification can be sent from the data platform 406 to remote servers, such as the first remote server 414 and a second remote server 416. The remote servers can request the first and second listing data via a pull request from the ground truth storage layer.

A first listing consumer 418 can be associated with a first remote server and a second listing consumer 420 can be associated with a second remote server, such as based on geographic location. As the first listing consumer requests access to the listings, the first remote server can supply display data for the first listing consumer to view the listing.

Once a listing is created with both metadata and rich data, the data platform establishes a “ground truth” version of this listing in a storage layer where the listing was created. As shown in FIG. 4, the listing's ground truth storage layer is within the remote server 422 where the first and second listing were created. Any updates made to the listing will first be reflected in this ground truth layer, ensuring there is a single, reliable source of truth for the listing.

By having listings with rich data, including executable code, stored in a ground truth layer and distributed worldwide, the platform enables listing providers to scale their offerings globally. Listing consumers can access, download, and install these data offerings with ease, maintaining a high degree of consistency and accessibility.

At block 304, the data platform receives an update on a first listing from a first listing provider. The data platform receives an update to an existing listing, allowing the listing provider to keep their listing current and relevant for potential listing consumers in the data marketplace.

The marketplace on the data platform can include a dynamic platform supporting continuous improvements, feature additions, or adjustments to listed services. Such updates can include new features or functionality, patches to security vulnerabilities, updates to documentation or metadata, improvements to compatibility with new platform or external dependencies, or responses to user feedback or industry trends.

The data platform receives this update from the listing provider and begins processing the update to ensure the listing reflects the latest changes. For example, the first listing provider, who originally created the listing, initiates an update.

At block 306, the data platform updates a ground truth storage layer based on the received update, the ground truth storage layer configured to store and maintain an up-to-date version of the listings for the data platform. The data platform updates a central, ground truth storage layer with the latest version of a listing based on updates, such as from the listing provider. The ground truth storage layer establishes a source of truth for each listing, ensuring that all global servers and listing consumers can access the most recent version of each listing, including rich data.

The ground truth storage layer can include a dedicated, repository where the latest, verified versions of all listings are stored. The ground truth storage layer eliminates discrepancies across regions, ensuring that every listing consumer has access to consistent, accurate, and up-to-date listing.

In some cases, when an update is initially received, the update is stored in the ground truth storage layer, isolating the update from the live listings to prevent any unverified or potentially unstable changes from affecting customer-facing environments. The platform may run compatibility checks, such as sandbox testing, to ensure the update is functional and capable of running within the platform's infrastructure. For example, sandbox tests may simulate the deployment environment to validate that the update doesn't disrupt other services or introduce performance issues.

In some cases, the platform confirms that any dependencies required by the updated listing are compatible with the data platform's environment. This validation step reduces the risk of installation or runtime errors for listing consumers. Dependency checks may include ensuring that required libraries or software components are available and compatible with the platform's environment. Dependency checks may include access controls and role permissions, confirming that the updated listing aligns with the appropriate access levels and roles defined within the platform. This helps prevent unauthorized access and maintains adherence to security protocols. Dependency checks may include platform-specific resources, verifying that resources such as storage allocations, processing power, or specific platform APIs are compatible with the updated listing.

The platform logs every update to ensure a comprehensive record of changes. This log serves as an audit trail, allowing the platform and listing providers to trace updates, understand changes, manage version history effectively, and roll back to a prior version (as further described herein).

A timestamp is added to indicate when the update was received and staged, allowing the platform to track the timing of changes. Each update can be assigned a unique version number, enabling easy reference and retrieval of specific versions if needed. The platform may request a description of the update from the listing provider. This description, stored in the log, provides context and purpose for each change, which is useful for understanding the evolution of the listing over time.

The log includes information about the listing provider and, potentially, the specific individual or automated system responsible for the update. This record ensures accountability and makes it easier to communicate with the correct stakeholders if issues arise. Version control ensures that the platform maintains an organized, accessible history of each listing's updates.

At block 308, the data platform sends an update notification to a plurality of remote servers of the update of the first listing stored in the ground truth storage layer. Once the update has been fully validated, tested, and logged, the update is integrated into the ground truth storage layer, designating the new version as the authoritative source of truth, making the update available for distribution across the platform. The platform marks the update as “ready for distribution” within the system, signaling to remote servers that the servers can begin requesting the update. In some cases, the data platform stores the update regardless of whether the update passes validation or testing and is flagged as invalid or failed such that the files still exist within the ground truth storage layer.

The platform prepares the update for global distribution by setting up notifications through the platform's global distribution system. This notification is sent to each remote server or deployment location. Each notification indicates that a new version of the listing is available in the ground truth storage layer, prompting remote servers to pull the latest data.

At block 310, the data platform receives a pull request of the update of the first listing from a first remote server of the plurality of remote servers. Once notified, remote servers worldwide recognize the update's availability and initiate a pull request to retrieve the latest version from the ground truth storage layer. This “pull” approach simplifies distribution, as each remote server independently requests the latest version, eliminating the need for the central platform to push and track updates to each server individually.

Each remote server pulls the update to ensure all listing consumers have access to the same version of the listing. This decentralized approach allows each server to retrieve updates based on local demand or network conditions, improving scalability and reducing latency. Since each server is prompted to pull from a single ground truth source, there is minimal risk of version inconsistency across locations.

At block 312, the data platform transmits the update of the first listing to the first remote server enabling display of the update to the first listing. This transmission makes the updated listing available for listing consumers in that server's region or jurisdiction.

By delivering the latest version from the ground truth storage to the remote server, the platform ensures that listing consumers accessing the marketplace from that remote server can view and interact with the most current version of the listing.

The data platform, upon receiving this pull request, verifies the server's authorization and checks that it is indeed the latest version available, ensuring data accuracy and security for the update transmission. The data platform prepares the update for secure transmission to the first remote server.

Once the update is staged and fully processed, the first remote server is ready to make the updated listing available to listing consumers in its region. The updated listing is displayed in the marketplace interface where customers browse available data offerings.

The remote server's update ensures version consistency across the marketplace. By pulling the update directly from the ground truth storage layer, the server checks that listing consumers in its region have access to the latest and verified version of the listing.

After the first remote server receives and distributes the update, other remote servers in different regions may follow similar steps, ensuring that the other servers reflect the latest ground truth version. In some cases, all remote servers request and process updates at the same time in parallel. In some cases, the remote servers request updates based on their individual needs, as further described herein.

The pull-based model allows each remote server to request updates when it is ready, making the system more scalable. The platform does not need to push updates to each server directly, reducing network strain and allowing servers to retrieve updates on their own schedule.

After the data platform sends an update notification, an assessment mechanism can be triggered to evaluate whether the update contains rich data—such as images, videos, executable code, or configuration manifests. If the update is determined to include only metadata or other lightweight elements without rich data, the data platform can directly push the update to remote servers. This approach minimizes latency and reduces the burden on remote servers, ensuring that simple updates are quickly distributed across the network.

In contrast, if the update contains rich data, the data platform signals the remote servers to initiate pull requests for the update. Rich data can require additional processing, security validation, and network resources, making the pull-based approach more suitable. This ensures that remote servers can manage the transfer of large or complex data elements autonomously, accounting for factors such as regional network conditions, compliance requirements, and server load. By allowing the remote servers to handle rich data updates through pull requests, the platform provides greater flexibility and ensures that resources are optimally utilized.

The data platform's remote servers employ a sophisticated, adaptable approach for pulling updates, enabling each server to manage updates independently and effectively based on various regional, regulatory, network, and demand-specific conditions.

Each remote server is designed to adapt its update-pulling process based on the specific region it serves or the unique needs of its customer base. This regional customization ensures that listings that are more relevant to a particular customer base or regulatory region can be prioritized, reducing latency for high-demand listings in those areas.

Each remote server can be tailored to adapt its update-pulling process according to the specific regional demands and customer needs it serves. Each server may not follow a one-size-fits-all approach; instead, each server dynamically customizes its update retrieval strategy based on factors like local demand, network infrastructure, and regulatory requirements. For example, in regions where certain listings are in high demand, the server can prioritize pulling updates for those services over others, ensuring that listing consumers have immediate access to the latest versions of popular listings. This prioritization helps minimize latency for critical updates, creating a responsive experience tailored to the interests and needs of listing consumers in that particular area.

Furthermore, this adaptability in update-pulling also considers network conditions and infrastructure variations across regions. In areas with limited bandwidth or network congestion, the server might pull updates in smaller data chunks, or during off-peak times, to ensure successful transfers without impacting network performance. Conversely, in regions with robust network infrastructure, updates can be retrieved in larger batches, reducing the time needed to make the latest listings available. This tailored approach optimizes performance across a diverse range of global network environments, ensuring that listing consumers receive a smooth, consistent experience regardless of where they are accessing the data platform. By allowing each remote server to adapt its pulling behavior in this way, the platform ensures that regional differences are respected while maintaining the overall efficiency and responsiveness of the marketplace.

Servers with high customer demand may pull updates more frequently or during off-peak times to minimize the impact on network resources. For example, a server in a region with high traffic for a specific service might prioritize pulling updates for that listing over less popular listings, ensuring a responsive experience for users in that area.

Servers in regions with high customer demand for specific services adapt their update-pulling frequency and timing to optimize both responsiveness and resource management. In areas where certain listings experience consistent high traffic, the server might pull updates for those listings more frequently, ensuring that users have the latest features, patches, and improvements as soon as they are available.

By focusing on high-demand listings, the server ensures a swift, responsive experience for listing consumers who rely on these services, reducing the chances of latency or delays in accessing up-to-date information. This approach aligns the update schedule with customer usage patterns, making the platform more responsive to the needs of its most active users.

Additionally, these servers may time their updates strategically, often choosing to pull updates during off-peak hours to avoid congestion and optimize network efficiency. By staggering update pulls to occur when customer activity is low, the servers can reduce the impact on network bandwidth and server load, balancing the need for timely updates with maintaining consistent performance for users actively engaged on the platform.

Off-peak update scheduling is particularly advantageous in high-demand regions, where a sudden surge of simultaneous update requests could otherwise strain resources and impact the platform's ability to serve real-time customer interactions. This strategy ensures that the servers stay up-to-date without compromising the experience for customers accessing the listings.

Prioritizing certain updates based on popularity further enhances the relevance and efficiency of the platform's update process. When a specific listing is highly popular in a given region, the server ensures that updates to this service are prioritized over less critical or less frequently accessed listings, guaranteeing that customers experience the best possible version of their most-used services.

By focusing resources on the listings that customers depend on most, the platform not only improves the user experience in high-demand regions but also optimizes its infrastructure to manage global resources effectively. This demand-based prioritization allows the data platform to scale intelligently, meeting customer expectations across different regions without compromising performance or responsiveness.

Remote servers can adjust their pulling behavior based on network constraints. In regions with limited bandwidth or network congestion, the server may throttle its pulling rate or break up the data into smaller, manageable chunks (see below for chunking details).

For regions under specific data regulations, like GDPR (General Data Protection Regulation) in the EU, servers may modify how they pull, store, and access data. For instance, servers may pull only data permissible within that regulatory region, and certain data fields may be omitted or encrypted to comply with privacy standards. The server might log access to specific fields for compliance audits, ensuring that updates meet local privacy requirements. Some regions or listing consumers may have access restrictions or content preferences, which may lead the server to selectively pull updates based on permitted content or locally approved versions.

Regional customization allows each server to comply with specific regulatory or compliance standards relevant to its location. For instance, a server operating in the European Union (EU) may adjust its update process to adhere to GDPR regulations, ensuring that data privacy standards are maintained when handling sensitive information. By tailoring update pulls based on these regional requirements, the server can comply with local laws while providing reliable, up-to-date services to its users.

For listings with large data sets or high-definition media files, remote servers may opt to pull data in chunked packages rather than in a single bulk transfer. This approach improves reliability and efficiency, especially under certain conditions.

By dividing the update into smaller chunks, the server minimizes the risk of failed transfers due to connection issues, reducing the need for full retries if a network interruption occurs. Each chunk can be processed with checkpointing, meaning that if the transfer is interrupted, it can resume from the last successful chunk rather than restarting from the beginning. High-priority sections of the listing can be pulled first, allowing essential data to be available sooner while the rest of the update continues in the background.

Each remote server can perform additional checks and optimizations during the update pull process to ensure reliability and maintain data integrity: The server dynamically manages its resources, balancing the pulling of updates with other tasks. This prevents overload on server resources, especially in high-traffic regions, and optimizes the distribution of bandwidth across multiple concurrent tasks.

The server is configured to automatically retry pulling if any part of the update fails, employing an exponential backoff or similar strategy to manage network constraints. This ensures that the server will eventually complete the update even in cases of intermittent network issues.

To confirm that each part of the update has been successfully transferred without corruption, the server performs checksums or hash verifications on received data. This helps confirm that the pulled data exactly matches the ground truth, ensuring that listing consumers are receiving accurate, unaltered versions of listings.

In some cases, the updates are distributed internally to a listing provider or listing consumer. The platform's internal distribution can support listings that are intended for selective access within specific, controlled groups, rather than for the platform's broader marketplace audience.

This allows listing providers or administrators to create an internal listing that is restricted to a designated subset of users, providing an effective way to control visibility and access based on user roles, departments, or any specific group within the organization. By limiting distribution to specific users or teams, the platform supports use cases where sensitive, proprietary, or experimental content is not intended for public distribution.

When a listing is created as an internal distribution, the listing and future updates are marked and configured to be visible only to those users who have been explicitly granted access.

This access control is managed across multiple dimensions, such as user permissions and/or distribution restrictions. For example, access to the listing is controlled through permissions, which define which users or groups within the platform can view or interact with the listing. These permissions can be role-based, where only those users with certain roles, such as internal testers, R&D staff, or specific project teams, are granted access. This ensures that sensitive listings remain isolated from general users who do not have authorization.

The data platform enforces distribution restrictions that limit where and how the listing can be distributed. For example, a listing might only be distributable within specific testing environments, staging areas, or internal servers, preventing it from being accessed in external or production environments. This restriction provides an additional security layer, ensuring that even users with viewing access cannot distribute the listing outside of pre-defined boundaries.

The platform can support different levels of distribution access, allowing listing providers to set precise control over who can see, interact with, and distribute the listing. These levels can be customized to fit various scenarios.

Listings can be completely restricted to internal access, meaning only select users within the organization can even see that the listing exists. This is useful for experimental features, early-stage developments, or proprietary services that should remain confidential until they are ready for broader release.

The listing can be configured to allow access only to certain roles (e.g., administrators, engineers, product testers) or specific teams within an organization. For example, a listing created for internal training purposes might only be visible to HR and training departments, while an internal testing feature might only be available to the engineering and QA teams.

Some listings may be available for a restricted period, allowing specific users to test or interact with the data for a short time before the listing is hidden again. This is particularly useful for time-sensitive projects or features that require feedback from a limited audience before a full rollout.

When transmitting updates, the platform can employ data encryption to meet stringent data protection standards. Encryption safeguards the data at every stage, from storage in the ground truth layer to transmission to remote servers, that may align with regulations such as HIPAA (Health Insurance Portability and Accountability Act) and GDPR (General Data Protection Regulation).

HIPAA requires the encryption of health-related data to protect against unauthorized access, especially during data transmission. To comply, the platform encrypts any sensitive health data within listings, such as patient records, medical device data, or health analytics, ensuring that unauthorized parties cannot access or tamper with the data.

Encryption can be applied both in transit (when data is being transmitted from the ground truth storage to remote servers) and at rest (when data is stored in either the ground truth storage layer or remote servers). This ensures that HIPAA-protected information remains secure across the entire data handling lifecycle, safeguarding it from potential breaches during transmission and storage.

GDPR places strong emphasis on data privacy, including strict requirements for encryption, data minimization, and access controls. To adhere to GDPR, the platform encrypts any personal data within listings, such as user information, IP addresses, or other identifiable data, before transmission.

The encryption protocols comply with GDPR's standards for data protection by design, ensuring that personal data is securely handled across borders, and giving organizations a mechanism to manage consent and data subject rights effectively. Additionally, in alignment with GDPR's data residency requirements, certain data may only be transmitted to servers within the EU or designated compliant regions, further enhancing security and privacy protections.

The ground truth storage layer serves as the central repository for all listings, including updates. Here, encryption is applied to data at rest, ensuring that all sensitive information within this central storage is protected even before it is transmitted. The encryption keys used are managed under strict access controls, preventing unauthorized access to the original, authoritative data stored in the ground truth.

This encryption can also support data segmentation and selective access, allowing only authorized parties and remote servers to decrypt and access specific portions of the data, thereby adhering to compliance standards and minimizing exposure.

When the update is pulled to a remote server, the platform ensures that encryption remains intact during transmission. The data arrives in encrypted form and is only decrypted once it reaches the secure environment of the remote server, where it is stored according to local or regional regulatory standards.

Remote servers, particularly those in regions governed by specific data protection laws (e.g., GDPR-compliant regions), apply encryption both during storage and whenever data is in use. This ensures that even if a remote server resides in a jurisdiction with specific data privacy requirements, the listing data remains compliant with both global and regional standards.

In cloud computing, having executable code embedded within a listing offers a powerful advantage by allowing listing consumers to immediately initiate and configure cloud-based services as soon as they sign onto or purchase a listing. This approach transforms the listing from a passive service description into an active deployment tool, empowering listing consumers to launch services with minimal setup.

The code in the listing is designed to be automatically executable upon installation, allowing it to kick-start the process of setting up, configuring, and optimizing the listing provider's service in the listing consumer's cloud environment. This capability significantly reduces the time and effort required for service deployment, which is critical in cloud-based environments where speed, scalability, and automation are key priorities.

Upon accessing or purchasing a listing, the embedded code can execute a series of automated tasks that prepare the listing consumer's cloud environment for the data offering. For example, the code could initiate provision resources that automatically allocate and configure resources like storage, compute power, or network settings needed to run the data offering effectively.

The code could set up access controls and permissions that define user roles, access levels, and security protocols within the listing consumer's cloud environment. This is particularly valuable when the listing requires specific permissions to interact with other systems, databases, or cloud resources.

The code can install dependencies that detect and install any software libraries, frameworks, or dependencies necessary for the service to operate, ensuring compatibility and reducing the risk of runtime errors.

For certain services, such as machine learning platforms, data analysis tools, or enterprise applications, the code in the listing can perform intricate configurations that would otherwise require considerable manual input. For instance, the code initializes databases and data pipelines where the code can set up databases or establish data ingestion pipelines that link the listing consumer's existing datasets to the new service.

The code can set APIs and integrations such as if the service requires connections to other cloud applications or APIs, the code can configure these integrations automatically, ensuring that the service is ready to operate within the listing consumer's ecosystem from day one.

The code can create virtual environments or isolated workspaces. In cases where the service requires isolated execution (e.g., for sensitive data processing), the code can establish secure, sandboxed environments tailored to the listing consumer's specifications, such as cleanrooms for data collaboration.

This immediacy is invaluable in cloud computing environments, where clients often prioritize agility and scalability. Quick deployment helps listing consumers get services up and running faster, reducing downtime and allowing teams to focus on productive work rather than setup.

One of the critical challenges in cloud computing is ensuring that new services are configured with the necessary security controls to protect sensitive data. The executable code in the listing can immediately set up access controls, encryption standards, and user permissions tailored to compliance requirements (e.g., HIPAA or GDPR), ensuring that the environment is secure before any sensitive data is transferred.

For example, if the service involves handling sensitive data in a cleanroom environment, the code can set up isolation protocols, define strict access permissions, and apply necessary security layers, creating a compliant environment that mitigates risks from the outset. This proactive security configuration is a key advantage for organizations in regulated industries.

As services evolve, updates to the executable code can be pushed through the listing to provide new features, patches, or optimizations. When the listing consumer accesses the listing after an update, the new version of the code can be executed to apply the latest changes seamlessly.

For listings related to data analytics or machine learning, where sensitive information is often involved, the embedded code can automatically establish a cleanroom environment prior to sensitive information being passed to the listing consumer. This cleanroom could be configured with strict access controls, isolated network settings, and encryption protocols to prevent unauthorized data access. By creating this controlled environment immediately upon installation, the listing ensures compliance with privacy regulations and enhances customer trust.

For collaborative applications, the code can define user roles and permissions, setting up a multi-user environment that aligns with the listing consumer's organizational structure. For instance, in a project management tool listing, the code may automatically set up administrator, editor, and viewer roles for team members, ensuring that the platform is ready for immediate, secure collaboration.

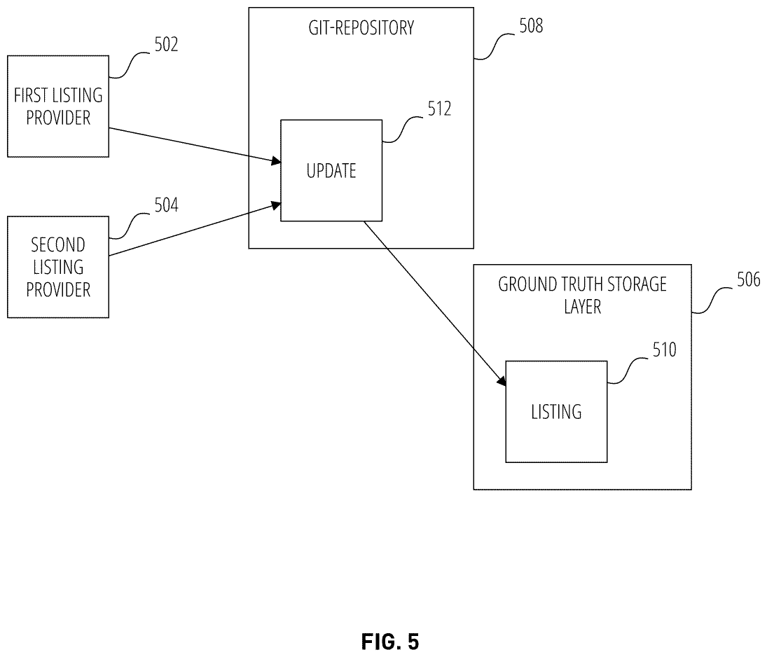

FIG. 5 illustrates joint collaboration on an update to a listing via a Git-based server repository, according to some examples. In some cases, the data platform incorporates a Git-based server repository 508 as part of the listing management system that introduces a highly collaborative, efficient, and version-controlled environment for managing cloud service listings. By integrating Git (or similar version control system), the platform enables multiple collaborators—such as developers, project managers, and QA teams—to jointly create, update, and refine the content and code associated with a listing. For example, a first listing provider 502 and a second listing provider 504 can collaboratively work on an update 512 before the update is sent to the ground truth storage layer 506 to update the listing 510.

This approach leverages the core capabilities of Git, such as branch management, pull requests, and commit histories, to streamline collaboration, ensure version accuracy, and maintain data integrity. Once updated and approved on Git, the ground truth storage layer on the platform reflects the latest approved version from the Git-based server, ensuring consistency and reliability across the data platform.

Git is a distributed version control system where each collaborator working on a listing can have their own copy of the repository. This setup allows team members to work independently on different features, bug fixes, or enhancements, without interfering with one another's work.

Each collaborator can commit changes locally, test them, and submit them for review before they are merged into the main listing. Distributed control is particularly useful for large development teams, as it allows multiple individuals to make progress on a listing simultaneously, reducing delays and enabling parallel development. This structure also enables remote and asynchronous work, accommodating global teams and diverse time zones.

The Git's branching model allows collaborators to create separate branches for new features, experimental changes, or bug fixes where multiple branches can coexist, each reflecting a unique update or addition to the listing, without impacting the primary or “production” version.

When changes in a branch are ready for inclusion in the main listing, a merge can be performed, integrating the changes from that branch into the mainline. By merging only approved changes, the Git system ensures that only stable, tested updates are included in the ground truth storage layer. Branching and merging provide an effective way to separate stable versions from those in development, allowing collaborators to test features without affecting the live listing.

Once a pull request is approved and changes are merged into the main branch, the Git-based repository synchronizes with the ground truth storage layer on the platform. The ground truth layer then updates to reflect the latest approved version, ensuring that this centralized version is always up-to-date with verified, reviewed changes.

In some cases, the platform can be configured to automate the synchronization between the Git-based repository and the ground truth storage layer. For instance, when changes are merged into the main branch of the Git repository, automated workflows (e.g., CI/CD pipelines) can trigger an update in the ground truth storage, ensuring that the latest version is promptly available.

This collaboration is particularly helpful for cloud environments, where listings often contain complex, feature-rich content that may require contributions from multiple specialists, such as developers, data scientists, and compliance experts.

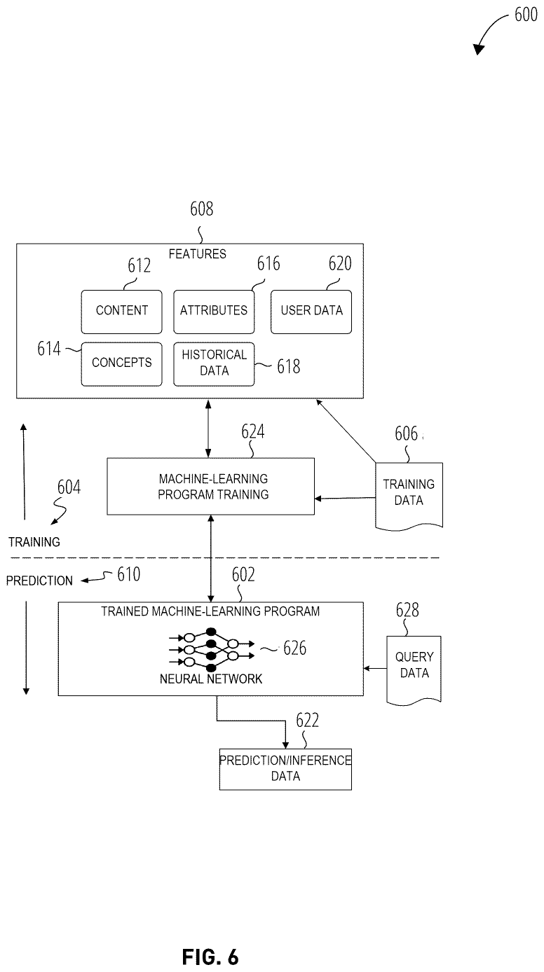

FIG. 6 illustrates further details of two example phases, namely a training phase 604 (e.g., part of the model selection and training 706) and a prediction phase 610 (part of prediction 710). Prior to the training phase 604, feature engineering 704 is used to identify features 608. This may include identifying informative, discriminating, and independent features for effectively operating the trained machine-learning program 602 in pattern recognition, classification, and regression. In some examples, the training data 606 includes labeled data, known for pre-identified features 608 and one or more outcomes. Each of the features 608 may be a variable or attribute, such as an individual measurable property of a process, article, system, or phenomenon represented by a data set (e.g., the training data 606). Features 608 may also be of different types, such as numeric features, strings, and graphs, and may include one or more of content 612, concepts 614, attributes 616, historical data 618, and/or user data 620, merely for example.

In training phase 604, the machine-learning pipeline 600 uses the training data 606 to find correlations among the features 608 that affect a predicted outcome or prediction/inference data 622.

With the training data 606 and the identified features 608, the trained machine-learning program 602 is trained during the training phase 604 during machine-learning program training 624. The machine-learning program training 624 appraises values of the features 608 as they correlate to the training data 606. The result of the training is the trained machine-learning program 602 (e.g., a trained or learned model).

Further, the training phase 604 may involve machine learning, in which the training data 606 is structured (e.g., labeled during preprocessing operations). The trained machine-learning program 602 implements a neural network 626 capable of performing, for example, classification and clustering operations. In other examples, the training phase 604 may involve deep learning, in which the training data 606 is unstructured, and the trained machine-learning program 602 implements a deep neural network 626 that can perform both feature extraction and classification/clustering operations.

In some examples, a neural network 626 may be generated during the training phase 604 and implemented within the trained machine-learning program 602. The neural network 626 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 626 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 626 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 604, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 610, the trained machine-learning program 602 uses the features 608 for analyzing query data 628 to generate inferences, outcomes, or predictions, as examples of a prediction/inference data 622. For example, during prediction phase 610, the trained machine-learning program 602 generates an output. Query data 628 is provided as an input to the trained machine-learning program 602, and the trained machine-learning program 602 generates the prediction/inference data 622 as output, responsive to receipt of the query data 628.

In some examples, the trained machine-learning program 602 may be a generative AI model. Generative AI is a term that may refer to any type of artificial intelligence that can create new content from training data 606. For example, generative AI can produce text, images, video, audio, code, or synthetic data similar to the original data but not identical.

Some of the techniques that may be used in generative AI are: Convolutional Neural Networks, Recurrent Neural Networks, generative adversarial networks, variational autoencoders, transformer models, and the like.

For example, Convolutional Neural Networks (CNNs) can be used for image recognition and computer vision tasks. CNNs may, for example, be designed to extract features from images by using filters or kernels that scan the input image and highlight important patterns. Recurrent Neural Networks (RNNs) can be used for processing sequential data, such as speech, text, and time series data, for example. RNNs employ feedback loops that allow them to capture temporal dependencies and remember past inputs. Generative adversarial networks (GANs) can include two neural networks: a generator and a discriminator. The generator network attempts to create realistic content that can “fool” the discriminator network, while the discriminator network attempts to distinguish between real and fake content. The generator and discriminator networks compete with each other and improve over time. Variational autoencoders (VAEs) can encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models can use attention mechanisms to learn the relationships between different parts of input data (such as words or pixels) and generate output data based on these relationships. Transformer models can handle sequential data, such as text or speech, as well as non-sequential data, such as images or code. In generative AI examples, the output prediction/inference data 622 can include predictions, translations, summaries, media content, and the like, or some combination thereof.

In some example embodiments, computer-readable files come in several varieties, including unstructured files, semi-structured files, and structured files. These terms may mean different things to different people. Examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data.

As used herein, examples of unstructured files include image files, video files, PDFs, audio files, and the like; examples of semi-structured files include JavaScript Object Notation (JSON) files, eXtensible Markup Language (XML) files, and the like. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a cloud data platform 102 can include one or more databases that are respectively maintained in association with any number of customer accounts (e.g., accounts of one or more data providers), as well as one or more databases associated with a system account (e.g., an administrative account) of the data platform, one or more other databases used for administrative purposes, and/or one or more other databases that are maintained in association with one or more other organizations and/or for any other purposes. A cloud data platform 102 may also store metadata (e.g., account object metadata) in association with the data platform in general and in association with, for example, particular databases and/or particular customer accounts as well. Users and/or executing processes that are associated with a given customer account may, via one or more types of clients, be able to cause data to be ingested into the database, and may also be able to manipulate the data, add additional data, remove data, run queries against the data, generate views of the data, and so forth. As used herein, the terms “account object metadata” and “account object” are used interchangeably.

In an implementation of a cloud data platform 102, a given database (e.g., a database maintained for a customer account) may reside as an object within, e.g., a customer account, which may also include one or more other objects (e.g., users, roles, grants, shares, warehouses, resource monitors, integrations, network policies, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

In the present disclosure, physical units of data that are stored in a cloud data platform—and that make up the content of, e.g., database tables in customer accounts (e.g., customer users)—are referred to as micro-partitions. In different implementations, a cloud data platform can store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the cloud data platform, a given file is referred to herein as an “internal file” and may be stored in (or at, or on, etc.) what is referred to herein as an “internal storage location.” If stored external to the cloud data platform, a given file is referred to herein as an “external file” and is referred to as being stored in (or at, or on, etc.) what is referred to herein as an “external storage location.”

While example embodiments of the present disclosure reference commands in the standardized syntax of the programming language Structured Query Language (SQL), it will be understood by one having ordinary skill in the art that the present disclosure can similarly apply to other programming languages associated with communicating and retrieving data from a database.

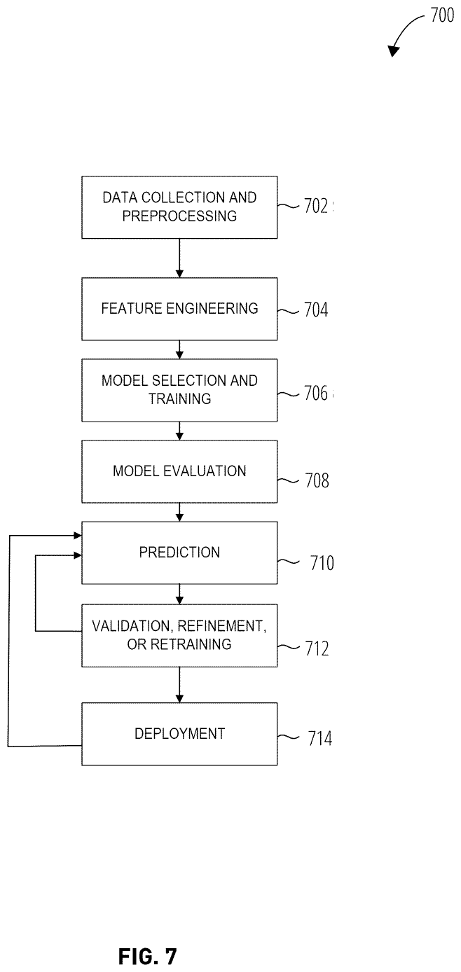

FIG. 7 depicts a machine-learning pipeline 700 and FIG. 7 illustrates training and use of a machine-learning program (e.g., model) 600. Specifically, FIG. 7 is a flowchart depicting a machine-learning pipeline 700, according to some examples. The machine-learning pipeline 700 can be used to generate a trained model, for example the trained machine-learning program 602 of FIG. 6, to perform operations associated with searches and query responses.

Broadly, machine learning may involve using computer algorithms to automatically learn patterns and relationships in data, potentially without the need for explicit programming. Machine learning algorithms can be divided into three main categories: supervised learning, unsupervised learning, self-supervised, and reinforcement learning.

For example, supervised learning involves training a model using labeled data to predict an output for new, unseen inputs. Examples of supervised learning algorithms include linear regression, decision trees, and neural networks. Unsupervised learning involves training a model on unlabeled data to find hidden patterns and relationships in the data. Examples of unsupervised learning algorithms include clustering, principal component analysis, and generative models like autoencoders. Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes'theorem and assumes that the predictor variables are independent of each other. Random Forest is another type of supervised learning algorithm used for classification, regression, and other tasks. Random Forest builds a collection of decision trees and combines their outputs to make predictions.

Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (e.g., is this object an apple or an orange?). Regression algorithms aim at quantifying some items (for example, by providing a value that is a real number).

Turning to the training phases 604 as described and depicted in connection with FIG. 7, generating a trained machine-learning program 602 may include multiple phases that form part of the machine-learning pipeline 700, including for example the following phases illustrated in FIG. 7: data collection and preprocessing 702, feature engineering 704, model selection and training 706, model evaluation 708, prediction 710, validation, refinement, or retraining 712, and deployment 714, or a combination thereof.

For example, data collection and preprocessing 702 can include a phase for acquiring and cleaning data to ensure that it is suitable for use in the machine learning model. This phase may also include removing duplicates, handling missing values, and converting data into a suitable format. Feature engineering 704 can include a phase for selecting and transforming the training data 606 to create features that are useful for predicting the target variable. Feature engineering may include (1) receiving features 608 (e.g., as structured or labeled data in supervised learning) and/or (2) identifying features 608 (e.g., unstructured, or unlabeled data for unsupervised learning) in training data 606. Model selection and training 706 can include a phase for selecting an appropriate machine learning algorithm and training it on the preprocessed data. This phase may further involve splitting the data into training and testing sets, using cross-validation to evaluate the model, and tuning hyperparameters to improve performance.

In additional examples, model evaluation 708 can include a phase for evaluating the performance of a trained model (e.g., the trained machine-learning program 602) on a separate testing dataset. This phase can help determine if the model is overfitting or underfitting and determine whether the model is suitable for deployment. Prediction 710 can include a phase for using a trained model (e.g., trained machine-learning program 602) to generate predictions on new, unseen data. Validation, refinement or retraining 712 can include a phase for updating a model based on feedback generated from the prediction phase, such as new data or user feedback. Deployment 714 can include a phase for integrating the trained model (e.g., the trained machine-learning program 602) into a more extensive system or application, such as a web service, mobile app, or IoT device. This phase can involve setting up APIs, building a user interface, and ensuring that the model is scalable and can handle large volumes of data.

In view of the disclosure above, various examples are set forth below. It should be noted that one or more features of an example, taken in isolation or combination, should be considered within the disclosure of this application.

Example 1 is a computer system comprising: at least one hardware processor; and at least one memory storing instructions that cause the at least one hardware processor to perform operations comprising: enabling third-party listing providers to upload listings for data offerings on a data platform, each listing comprising file-based data with metadata and rich data, the rich data comprising executable code enabling customers to access the data offerings on the data platform; receiving an update on a first listing from a first third-party listing provider; updating a ground truth storage layer based on the received update, the ground truth storage layer configured to store and maintain an up-to-date version of the listings for the data offerings; sending an update notification to a plurality of remote servers of the update of the first listing stored in the ground truth storage layer; receiving a pull request of the update of the first listing from a first remote server of the plurality of remote servers; and transmitting the update of the first listing to the first remote server enabling display of the update to the first listing.

In Example 2, the subject matter of Example 1 includes, wherein the operations further comprise: subsequent to updating the ground truth storage layer and prior to sending the update notification, performing a compatibility check on the update to the first listing, and sending the update notification in response to passing the compatibility check on the update.

In Example 3, the subject matter of Example 2 includes, wherein the compatibility check comprises checking dependencies to access of data stored within a cloud server.

In Example 4, the subject matter of Examples 1-3 includes, wherein the first remote server transmits the pull request based on load balancing of the first remote server.

In Example 5, the subject matter of Examples 1-4 includes, wherein the first remote server keeps track of the update and requests a retry attempt via an additional pull request from the data platform without the data platform keeping track of the update at the first remote server.

In Example 6, the subject matter of Examples 1-5 includes, wherein the first remote server transmits the pull request based on a particular geographic location that the first remote server serves for the first listing.

In Example 7, the subject matter of Examples 1-6 includes, wherein the first remote server transmits the pull request based on current customer demand on the first remote server.

In Example 8, the subject matter of Examples 1-7 includes, wherein the first remote server transmits the pull request based on a local regulation of a geographic region served by the first remote server.

In Example 9, the subject matter of Examples 1-8 includes, wherein the pull request is one of a plurality of pull requests, each pull request requesting a transfer of a portion of the update to the first listing.

In Example 10, the subject matter of Examples 1-9 includes, wherein the data platform identifies an access control for the pull request and selectively transmits the update based on the access control.

In Example 11, the subject matter of Examples 1-10 includes, wherein the first listing comprises executable code, wherein the update further comprises an update to the executable code for the first listing, wherein in response to a customer device selecting the updated listing, the first remote server initiates execution of the updated executable code on the customer device.

In Example 12, the subject matter of Example 11 includes, wherein the execution of the updated executable code in response to the selecting by the customer device of the updated listing causes a provision of resources that automatically allocate storage and compute power for one or more services for a service associated with the updated listing.

In Example 13, the subject matter of Examples 11-12 includes, wherein the execution of the updated executable code in response to the selecting by the customer device of the updated listing causes setting of one or more access controls and permissions that define user roles and security protocols within a cloud environment associated with the customer device.

In Example 14, the subject matter of Examples 11-13 includes, wherein the execution of the updated executable code in response to the selecting by the customer device of the updated listing causes setting of dependencies that install software libraries for a service associated with the updated listing.

In Example 15, the subject matter of Examples 11-14 includes, wherein the execution of the updated executable code in response to the selecting by the customer device of the updated listing causes an establishment of a cleanroom environment prior to sensitive information being stored by the customer device.

In Example 16, the subject matter of Examples 1-15 includes, wherein the operations further comprise: incorporating a Git-based server repository for the first listing prior to the update; enabling multiple collaborators to jointly create updates to the first listing; and merging the updates by the multiple collaborators to generate the update, wherein updating of the ground truth storage layer comprises updating the first listing to incorporate the updates by the multiple collaborators.

Example 17 is a method performed by at least one hardware processor, the method comprising: enabling third-party listing providers to upload listings for data offerings on a data platform, each listing comprising file-based data with metadata and rich data, the rich data comprising executable code enabling customers to access the data offerings on the data platform; receiving an update on a first listing from a first third-party listing provider; updating a ground truth storage layer based on the received update, the ground truth storage layer configured to store and maintain an up-to-date version of the listings for the data offerings; sending an update notification to a plurality of remote servers of the update of the first listing stored in the ground truth storage layer; receiving a pull request of the update of the first listing from a first remote server of the plurality of remote servers; and transmitting the update of the first listing to the first remote server enabling display of the update to the first listing.

In Example 18, the subject matter of Example 17 includes, wherein the operations further comprise: subsequent to updating the ground truth storage layer and prior to sending the update notification, performing a compatibility check on the update to the first listing, and sending the update notification in response to passing the compatibility check on the update.

In Example 19, the subject matter of Example 18 includes, wherein the compatibility check comprises checking dependencies to access of data stored within a cloud server.

Example 20 is computer-storage media comprising instructions that, when executed by one or more processors of a machine, configure the machine to perform operations comprising: enabling third-party listing providers to upload listings for data offerings on a data platform, each listing comprising file-based data with metadata and rich data, the rich data comprising executable code enabling customers to access the data offerings on the data platform; receiving an update on a first listing from a first third-party listing provider; updating a ground truth storage layer based on the received update, the ground truth storage layer configured to store and maintain an up-to-date version of the listings for the data offerings; sending an update notification to a plurality of remote servers of the update of the first listing stored in the ground truth storage layer; receiving a pull request of the update of the first listing from a first remote server of the plurality of remote servers; and transmitting the update of the first listing to the first remote server enabling display of the update to the first listing.

Example 21 is at least one machine-readable medium including instructions that, when executed by processing circuitry, cause the processing circuitry to perform operations to implement of any of Examples 1-20.

Example 22 is an apparatus comprising means to implement any of Examples 1-20.

Example 23 is a system to implement any of Examples 1-20.

Example 24 is a method to implement any of Examples 1-20.

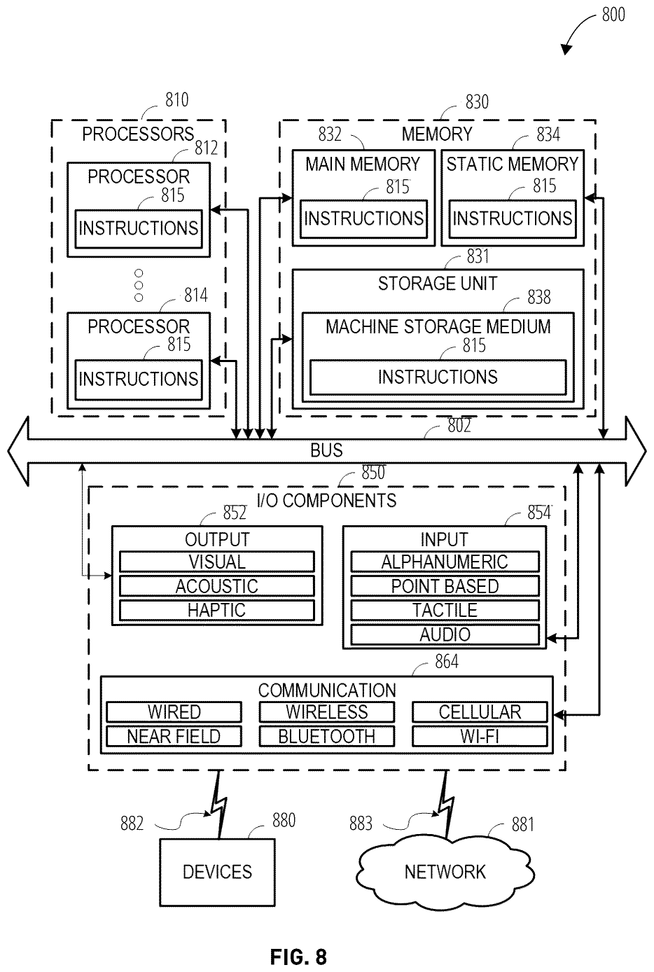

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 815 (e.g., software, a program, an application, an applet, an app, or other executable code), for causing the machine 800 to perform any one or more of the methodologies discussed herein, may be executed. For example, the instructions 815 may cause the machine 800 to implement portions of the data flows described herein. In this way, the instructions 815 transform a general, non-programmed machine into a particular machine 800 (e.g., the client device 112 of FIG. 1, the compute service manager 108 of FIG. 1, the execution platform 110 of FIG. 1) that is specially configured to carry out any one of the described and illustrated functions in the manner described herein.

In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 815, sequentially or otherwise, that specify actions to be taken by the machine 800. Further, while only a single machine 800 is illustrated, the term “machine” shall also be taken to include a collection of machines 800 that individually or jointly execute the instructions 815 to perform any one or more of the methodologies discussed herein.

The machine 800 includes processors 810 (such as processor 812 and processor 814), memory 830, and input/output (I/O) I/O components 850 (including output components 852 and input components 854) configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 815. The term “processor” is intended to include multi-core processors 810 that may comprise two or more independent processors (sometimes referred to as “cores”) that may execute instructions 815 contemporaneously. Although FIG. 8 shows multiple processors 810, the machine 800 may include a single processor with a single core, a single processor with multiple cores (e.g., a multi-core processor), multiple processors with a single core, multiple processors with multiple cores, or any combination thereof.

The memory 830 may include a main memory 832, a static memory 834, and a storage unit 831, all accessible to the processors 810 such as via the bus 802. The main memory 832, the static memory 834, and the storage unit 831 comprise a machine storage medium 838 that may store the instructions 815 embodying any one or more of the methodologies or functions described herein. The instructions 815 may also reside, completely or partially, within the main memory 832, within the static memory 834, within the storage unit 831, within at least one of the processors 810 (e.g., within the processor's cache memory), or any suitable combination thereof, during execution thereof by the machine 800.

The I/O components 850 include components to receive input, provide output, produce output, transmit information, exchange information, capture measurements, and so on. The specific I/O components 850 that are included in a particular machine 800 will depend on the type of machine. For example, portable machines, such as mobile phones, will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 850 may include communication components 864 operable to couple the machine machine 800 to a network 881 via a coupler 883 or to devices 880 via a coupling 882. For example, the communication components 864 may include a network interface component or another suitable device to interface with the network 881. In further examples, the communication components 864 may include wired communication components, wireless communication components, cellular communication components, and other communication components to provide communication via other modalities. The devices 880 may be another machine or any of a wide variety of peripheral devices (e.g., a peripheral device coupled via a universal serial bus (USB)). For example, as noted above, the machine 800 may correspond to any one of the client device 112, the compute service manager 108, and the execution platform 110, and may include any other of these systems and devices.

The various memories (e.g., 830, 832, 834, and/or memory of the processor(s) 810 and/or the storage unit 831) may store one or more sets of instructions 815 and data structures (e.g., software), embodying or utilized by any one or more of the methodologies or functions described herein. These instructions 815, when executed by the processor(s) 810, cause various operations to implement the disclosed embodiments.

Another general aspect is for a system that includes a memory comprising instructions and one or more computer processors or one or more hardware processors. The instructions, when executed by the one or more computer processors, cause the one or more computer processors to perform operations. In yet another general aspect, a tangible machine-readable storage medium (e.g., a non-transitory storage medium) includes instructions that, when executed by a machine, cause the machine to perform operations.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, (e.g., erasable programmable read-only memory (EPROM), electrically erasable programmable read-only memory (EEPROM), field-programmable gate arrays (FPGAs), and flash memory devices); magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 881 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 881 or a portion of the network 881 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 815 may be transmitted or received over the network 881 using a transmission medium via a network interface device (e.g., a network interface component included in the communication components 864) and utilizing any one of a number of well-known transfer protocols (e.g., hypertext transfer protocol (HTTP)). Similarly, the instructions 815 may be transmitted or received using a transmission medium via the coupling 882 (e.g., a peer-to-peer coupling) to the devices 880. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 815 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A computer system comprising:
at least one hardware processor; and
at least one memory storing instructions that cause the at least one hardware processor to perform operations comprising:
enabling third-party listing providers to upload listings for data offerings on a data platform, each listing comprising file-based data with metadata and rich data;
receiving an update on a first listing from a first third-party listing provider;
updating a ground truth storage layer based on the received update, the ground truth storage layer configured to store and maintain an up-to-date version of the listings for the data offerings;
sending an update notification to a plurality of remote servers of the update of the first listing stored in the ground truth storage layer;
receiving a pull request of the update of the first listing from a first remote server of the plurality of remote servers; and
transmitting the update of the first listing to the first remote server enabling display of the update to the first listing.

2. The computer system of claim 1, wherein the operations further comprise:
subsequent to updating the ground truth storage layer and prior to sending the update notification, performing a check on the update to the first listing, and sending the update notification in response to passing the check on the update.

3. The computer system of claim 1, wherein the first remote server transmits the pull request based on load balancing of the first remote server.

4. The computer system of claim 1, wherein the first remote server keeps track of the update and requests a retry attempt via an additional pull request from the data platform without the data platform keeping track of the update at the first remote server.

5. The computer system of claim 1, wherein the first remote server transmits the pull request based on a particular geographic location that the first remote server serves for the first listing.

6. The computer system of claim 1, wherein the first remote server transmits the pull request based on current customer demand on the first remote server.

7. The computer system of claim 1, wherein the first remote server transmits the pull request based on a local regulation of a geographic region served by the first remote server.

8. The computer system of claim 1, wherein the pull request is one of a plurality of pull requests, each pull request requesting a transfer of a portion of the update to the first listing.

9. The computer system of claim 1, wherein the data platform identifies an access control for the pull request and selectively transmits the update based on the access control.

10. The computer system of claim 1, wherein the first listing comprises executable code, wherein the update further comprises an update to the executable code for the first listing, wherein in response to a customer device selecting the updated listing, the first remote server initiates execution of the updated executable code on the customer device.

11. The computer system of claim 10, wherein the execution of the updated executable code in response to the selecting by the customer device of the updated listing causes a provision of resources that automatically allocate storage and compute power for one or more services for a service associated with the updated listing.

12. The computer system of claim 10, wherein the execution of the updated executable code in response to the selecting by the customer device of the updated listing causes setting of one or more access controls and permissions that define user roles and security protocols within a cloud environment associated with the customer device.

13. The computer system of claim 11, wherein the execution of the updated executable code in response to the selecting by the customer device of the updated listing causes an establishment of a cleanroom environment prior to sensitive information being stored by the customer device.

14. The computer system of claim 1, wherein the operations further comprise:
incorporating a Git-based server repository for the first listing prior to the update;
enabling multiple collaborators to jointly create updates to the first listing; and
merging the updates by the multiple collaborators to generate the update,
wherein updating of the ground truth storage layer comprises updating the first listing to incorporate the updates by the multiple collaborators.

15. The computer system of claim 1, wherein sending the update notification further comprises assessing the update to determine whether the update includes rich data, and the operations further comprising:
(a) in response to determining that the update does not include rich data, pushing the update directly from the data platform to the plurality of remote servers; and
(b) in response to determining that the update includes rich data, enabling the plurality of remote servers to initiate pull requests for the update from the data platform.

16. The computer system of claim 1, wherein the rich data comprises manifest files, and the operations further comprising:
(a) storing multiple versions of the manifest files associated with the first listing in the ground truth storage layer, each version representing a snapshot at a specific point in time; and
(b) enabling the first third-party listing provider to rollback the first listing to a previous version of the manifest file, thereby restoring a prior version of the listing.

17. A method performed by at least one hardware processor, the method comprising:
enabling third-party listing providers to upload listings for data offerings on a data platform, each listing comprising file-based data with metadata and rich data;
receiving an update on a first listing from a first third-party listing provider;
updating a ground truth storage layer based on the received update, the ground truth storage layer configured to store and maintain an up-to-date version of the listings for the data offerings;
sending an update notification to a plurality of remote servers of the update of the first listing stored in the ground truth storage layer;
receiving a pull request of the update of the first listing from a first remote server of the plurality of remote servers; and
transmitting the update of the first listing to the first remote server enabling display of the update to the first listing.

18. The method of claim 17, wherein the operations further comprise:
subsequent to updating the ground truth storage layer and prior to sending the update notification, performing a compatibility check on the update to the first listing, and sending the update notification in response to passing the compatibility check on the update.

19. The method of claim 17, wherein the first remote server transmits the pull request based on load balancing of the first remote server.

20. Computer-storage media comprising instructions that, when executed by one or more processors of a machine, configure the machine to perform operations comprising:
enabling third-party listing providers to upload listings for data offerings on a data platform, each listing comprising file-based data with metadata and rich data;
receiving an update on a first listing from a first third-party listing provider;
updating a ground truth storage layer based on the received update, the ground truth storage layer configured to store and maintain an up-to-date version of the listings for the data offerings;
sending an update notification to a plurality of remote servers of the update of the first listing stored in the ground truth storage layer;
receiving a pull request of the update of the first listing from a first remote server of the plurality of remote servers; and
transmitting the update of the first listing to the first remote server enabling display of the update to the first listing.
